(19) United States
(12) Patent Application Publication
(10) Pub. No.: US 2014/0332647 A1
(43) Pub. Date: Nov. 13, 2014

(54) COUPLING DEVICE

(71) Applicant: ACCTON TECHNOLOGY CORPORATION, Hsinchu (TW)

(72) Inventor: Hung-Feng TAI, Taoyuan County (TW)

(73) Assignee: ACCTON TECHNOLOGY CORPORATION, Hsinchu (TW)

(21) Appl. No.: 14/031,903

(22) Filed: Sep. 19, 2013

(30) Foreign Application Priority Data
May 13, 2013 (TW) 102116901

(51) Int. Cl. F16M 13/02

(52) U.S. Cl. CPC F16M 13/02
USPC 248/205.1

(57) ABSTRACT

A coupling device includes a first member and a second member. The first member has a first base and a first conjunction, wherein the first base has a first end and a second end; the first conjunction has at least two first surfaces facing each other, and a distance between the first surfaces near the second end is shorter than a distance between the first surfaces near the first end. The second member has a second base and a second conjunction, wherein the second base has a third end and a fourth end; the second conjunction has at least two second surfaces facing away from each other, and a distance between the second surfaces near the fourth end is shorter than a distance between the second surfaces near the third end. The first member and the second member can be coupled by abutting the second surfaces against the first surfaces.

The current application claims a foreign priority to the patent application of Taiwan No. 102116901 filed on May 13, 2013.

### BACKGROUND OF THE INVENTION

1. Field of the Invention

The present invention relates generally to a coupling and securing structure, and more particularly to a coupling device. 2. Description of the Related Art

Network devices such as servers or routers are usually secured onto a fixed rack or a fixed case while operating, and FIG. 1 shows a conventional design to secure a network device 200. There are two L-shaped plates 210 respectively connected to opposite sides of the network device 200, and the network device 200 is secured onto a rack 230 by screwing bolts 220 onto the rack 300 through the plates 210. However, along with the increasing demand of network communication nowadays, the network device 200 is becoming heavier and larger, and the conventional design is gradually insufficient for keeping the network device 200 staying at a purposed location. After being secured onto the rack 230 for a period of time, the network device 200 may tilt, deform, or even fall down, because of its own weight. Besides, the plates 220 have to be aimed at the rack 230 precisely for screwing the bolts 220, which is inconvenient at installing.

Therefore, there are racks provided with several rows of guide rails, and network devices can be placed onto the guide rails to prevent from tilting and inconvenient installation as mentioned above. But the guide rails cost more, and their structure is too complicated to easily maintain.

### SUMMARY OF THE INVENTION

The primary objective of the present invention is to provide a coupling device, which has a simple structure, less cost, quick assembling and firm securing.

According to the objective of the present invention, the present invention provides a coupling device used for coupling two objects. The coupling device comprises a first member and a second member, wherein the first member has a first base and a first junction, and the first base has a first end and a second end at opposite sides thereof; the first junction has at least two first surfaces which face toward each other, and a distance between ends of the first surfaces near the second end is shorter than a distance between ends of the first surfaces near the first end; the second member has a second base and a second junction, wherein the second base has a third end and a fourth end at opposite sides thereof; the second junction has at least two second surfaces which face away from each other, and a distance between ends of the second surfaces near the fourth end is shorter than a distance between ends of the second surfaces near the third end. Whereby, the first member and the second member can be coupled by abutting the second surfaces against the first surfaces.

With the design of the present invention, the coupling device has several advantages such as low cost, simple structure, and can be used for quick and firm securing.

### BRIEF DESCRIPTION OF THE DRAWINGS

FIG. 1 is a perspective view of the conventional design for securing a network device;

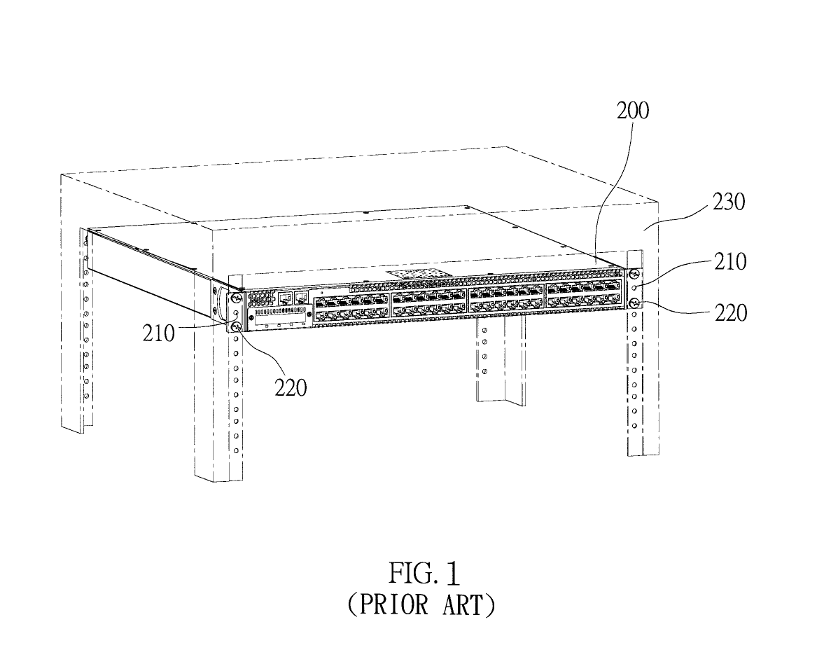

FIG. 2 is an exploded view of a first preferred embodiment of the present invention;

FIG. 3 is a perspective view of the first preferred embodiment of the present invention;

FIG. 4 is a perspective view of the first member of the first preferred embodiment of the present invention;

FIG. 5 is a side view of the first member of the first preferred embodiment of the present invention;

FIG. 6 is a perspective view of the second member of the first preferred embodiment of the present invention;

FIG. 7 is a side view of the second member of the first preferred embodiment of the present invention;

FIG. 8 is a perspective view of the first preferred embodiment of the present invention, showing a network device going to be secured onto a rack;

FIG. 9 is a perspective view of the first preferred embodiment of the present invention, showing the network device secured onto the rack;

FIG. 10 is an exploded view of a second preferred embodiment of the present invention; and

FIG. 11 is an exploded view of a third preferred embodiment of the present invention.

### DETAILED DESCRIPTION OF THE INVENTION

The detailed description and technical contents of the present invention will be explained with reference to the accompanying drawings. However, the drawings are illustrative only but not used to limit the present invention.

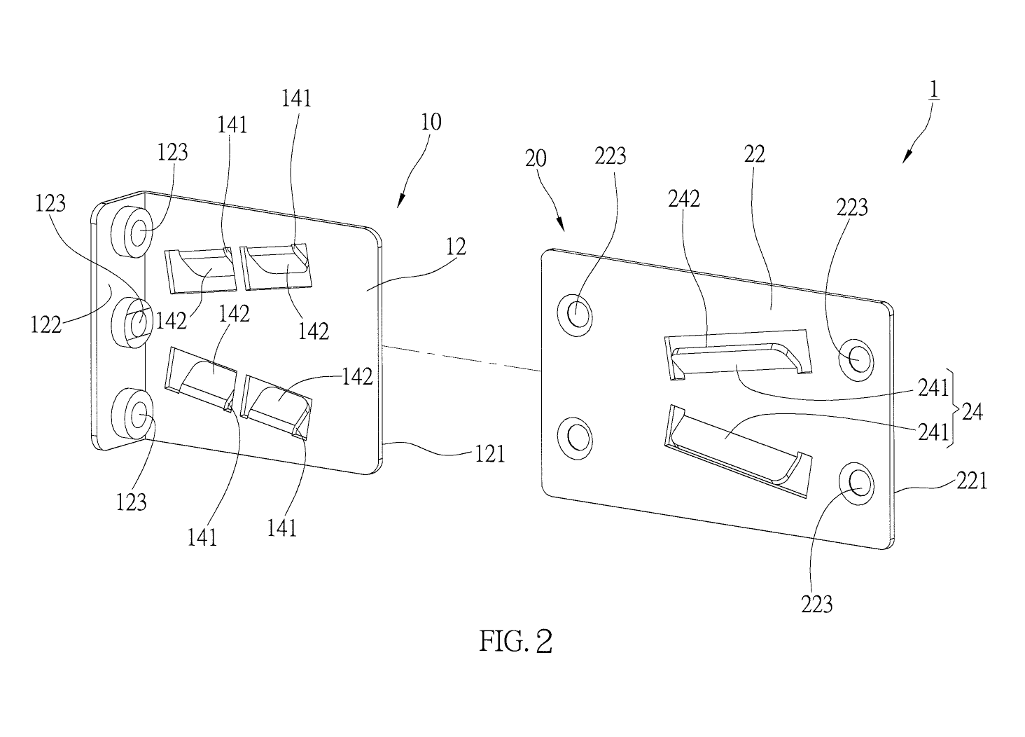

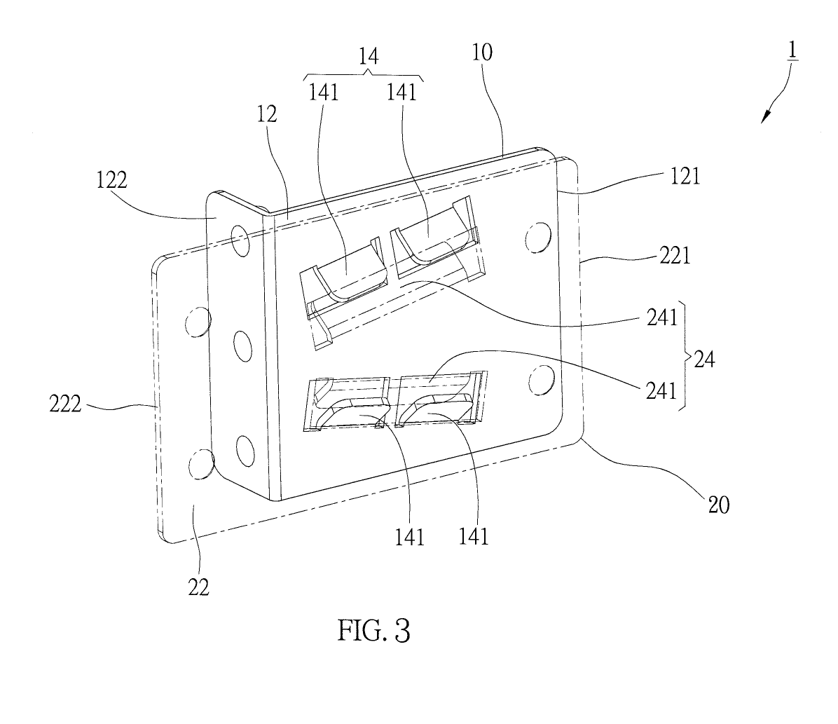

As shown in FIG. 2 and FIG. 3, a coupling device 1 of the preferred embodiment of the present invention includes a first member 10 and a second member 20.

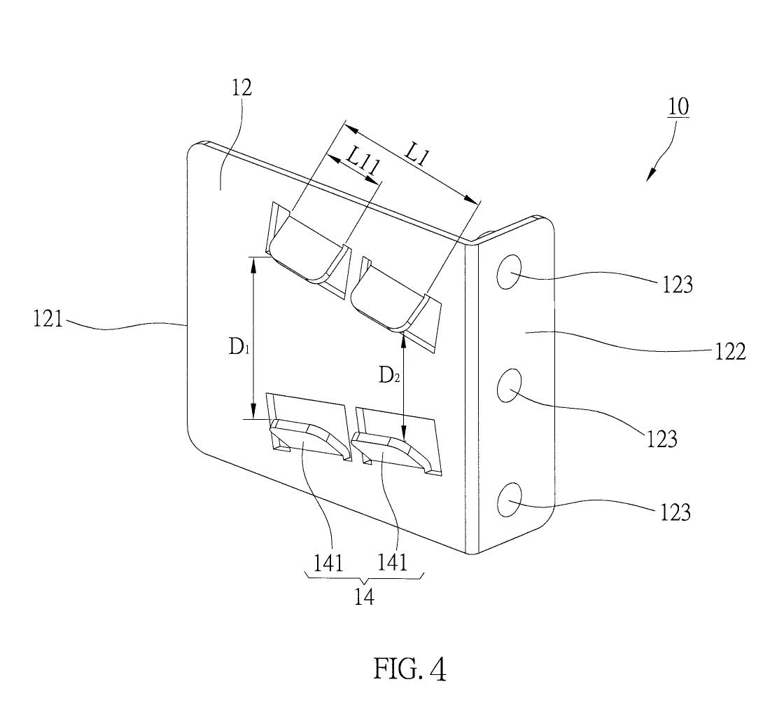

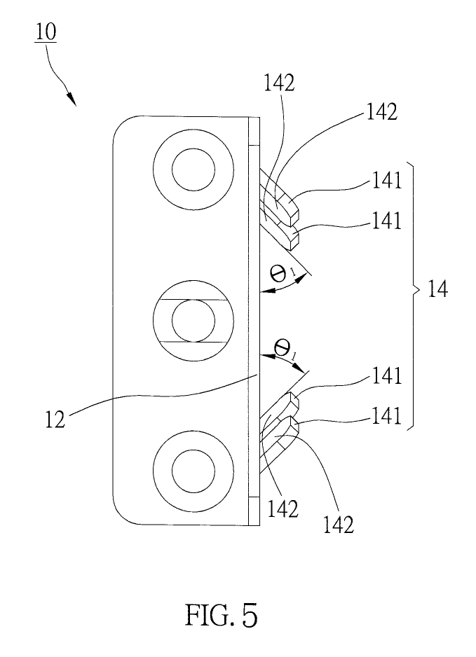

FIG. 4 and FIG. 5 show that the first member 10 is an integrated metal plate made by impact molding. The first member 10 has a first base 12 and a first conjunction 14. The first base 12 has a first end 121 and a second end 122 at opposite sides, and the first base 12 furthermore has a plurality of through holes 123 near the second end 122. The first conjunction 14 has four plates 141 symmetrically by two rows, and each two neighboring plates 141 of the same row are separated with a predetermined distance. Each plate 141 has a first surface 142, and the first surface 142 of the plate 141 faces and expands toward the first surface 142 of the corresponding plate 141 of the other row. The corresponding plates 141 lean toward each other from the first base 12. As a result, a angle θ₁ between each first surface 142 and the surface of the first base 12 is less than 90 degrees. Since the plates 141 of the first conjunction 14 are designed as separated parts of each row, the structure of the first conjunction 14 is simplified, and therefore the manufacturing process of the first member 10 consumes less material, and saves more cost. This is an advantage of the present invention, but the present invention is not limited by the above description. For stronger coupling device, there could be only single plate 141 of each row in another embodiment instead of separating design. The distance between two corresponding first surfaces 142 of different rows gradually reduces from the first end 121 to the second end 122. In other words, the distance D1 between two corresponding first surfaces 142 near the first end 121 is longer than the distance D2 between two corresponding first surfaces 142 near the second end 122. In addition, the manufacturing technique of the first member 10 is not limited as mentioned above; the first member 10 of the present invention could be made from alloy, engineering plastics, or any suitable materials, and the production method could be welding or assembling in other embodiments.

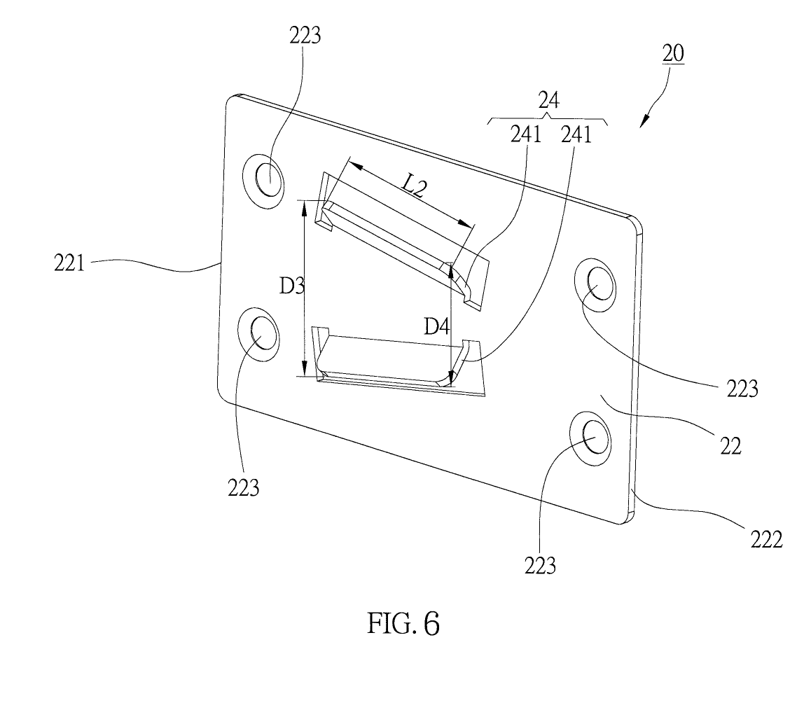

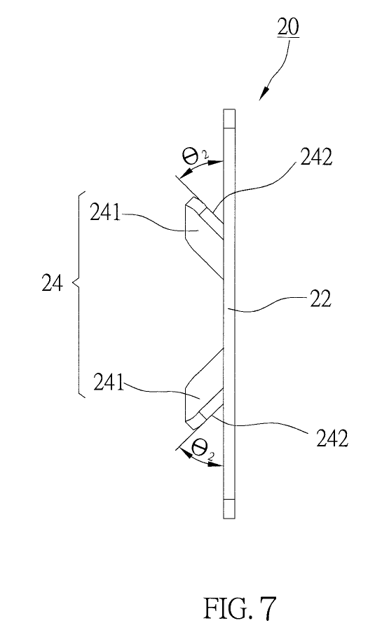

As shown in FIG. 6 and FIG. 7, the second member 20 is used to couple with the first member 10, and the second member 20 is an integrated metal plate made by impact molding as well. Similar to the first member 10, the second member 20 has a second base 22 and a second conjunction 24. The second base 22 has a third end 221 and a fourth end 222 at opposite sides, and the second base 22 has a plurality of through holes 223. The second conjunction 24 has two long plates 241 symmetrically. In other embodiments, the second conjunction 24 also could have a plurality of separated plates of each row to simplify the structure of the second conjunction 21, and to save materials and cost for manufacturing just as the aforementioned first conjunction 14. Lengths L2 of the plates 241 is longer than lengths L11 of each plate 141 and the total length L1 of the first conjunction 14. In other embodiment, if the first conjunction 14 was designed as a plurality of separated plates 141 of each row, the length L2 of the plate 241 has to be longer than the distance between the neighboring plates 141 of the same row. In other embodiments which the second conjunction 24 is designed as a plurality of separated plates, the length of each plate of the second conjunction 24 has to be longer than the distance between the neighboring plates 141 of the same row. Each plate 241 has a second surface 242, and the second surface 242 of the plate 241 faces and expands outwards the second surface 242 of the corresponding plate 241 of the other row. The corresponding plates 241 lean away from each other from the first base 12. As a result, a angle θ₂ between each second surface 242 and the surface of the second base 22 is less than 90 degrees, and the angle θ₂ equals the angle θ₁. Of course, the manufacturing technique of the second member 20 is not limited as mentioned above either; the second member 20 of the present invention could be made from alloy, engineering plastics, or any suitable materials, and the production method could be welding or assembling as well in other embodiments. A distance between the two second surfaces 242 gradually reduces from ends thereof near the third end 221 to ends near the fourth end 222, and the slope of the second surfaces 242 corresponds to the slope of the first surfaces 142 of the first member 10. In other words, the distance D3 between the ends of the two second surfaces 242 near the third end 221 is longer than the distance D4 between the ends of the two second surfaces 242 near the fourth end 222. Since the slope of the second surfaces 242 corresponds to the slope of the first surfaces 142 of the first member 10, and the angle θ₂ equals the angle θ₁, when the first member 10 and the second member 20 being coupled, the first surfaces 142 of the first conjunction 14 and the second surfaces 242 of the second conjunction 24 could abut against each other properly.

Whereby, when a user wants to couple the second member 20 to the first member 10, he/she could move the fourth end 222 of the second member 20 toward the first end 121 of the first member 10 to let the second conjunction 24 engage with the first conjunction 14. With aforementioned corresponding slopes of the first surfaces 142 and the second surfaces 242, the distance between the ends of two first surfaces 142 near the first end 121 is longer than the distance between the ends of the two second surfaces 242 near the fourth end 222, and therefore the second member 20 could be guided quickly to the first member 10. Since the slope of the second surfaces 242 corresponds to the slope of the first surfaces 142 of the first member 10, and the plates 141 of different rows are getting closer from the first end 121 toward the second end 122 (so are the first surfaces 142), the second member 20 could be guided gradually to the purposed position, and finally coupled with the first member 10 firmly. Once the two second surfaces 242 abut against the first surfaces 142, the first member 10 and the second member 20 is coupled. In addition, because the lengths L2 of the plates 241 are longer than the length L11 of the plates 141 and the total length L1 of the first conjunction 14, when the second conjunction 24 and the first conjunction 14 is coupled, each plate 241 of the second conjunction 24 is supported by the first conjunction 14; and the plates 241 won't be hindered by the separation between two neighboring plates 141 while the second member 20 being moved. Furthermore, the aforementioned angle θ₁ and θ₂ are less than 90 degrees, such design provides supporting forces from both sides when the first member 10 and the second member 20 are coupled horizontally (i.e., the first member 10 and the second member 20 are placed left and right), and provides hanging forces when the first member 10 and the second member 20 are coupled vertically (i.e., the first member 10 and the second member 20 are placed up and down).

As mentioned above, the first surfaces 142 of different rows of the first conjunction 14 are getting closer from the first end 121 to the second end 122, and the second surfaces 242 of the second conjunction 24 are getting closer from the third end 221 to the fourth end 222, and therefore a corresponding angle is formed between the first surfaces 142 and the second surfaces 242. In other words, the angle formed by the two rows of the first conjunction 14 is corresponding to the angle formed by the two rows of the second conjunction 24. Besides, the angle θ₁ is formed between the first surfaces 142 and the surface of the first base 12, and the angle θ₂ is formed between the second surfaces 242 and the surface of the second base 22. Therefore, the coupling device 1 of the present invention has corresponding slope for the first surfaces 142 and the second surfaces 242, as shown in FIG. 2; on the other hand, there is a corresponding angle between the plates 141 and the first base 12, and there is a corresponding angle between the plates 241 and the second base 22, as shown in FIG. 5 and FIG. 7.

It is worth mentioning that when the second member 20 is coupled with the first member 10, the third end 221 of the second base 22 and the first end 121 of the first base 12 are facing toward the same direction, and the second member 20 can be separated from the first member 10 by moving the second member 20 toward the third end 221 for a predetermined distance.

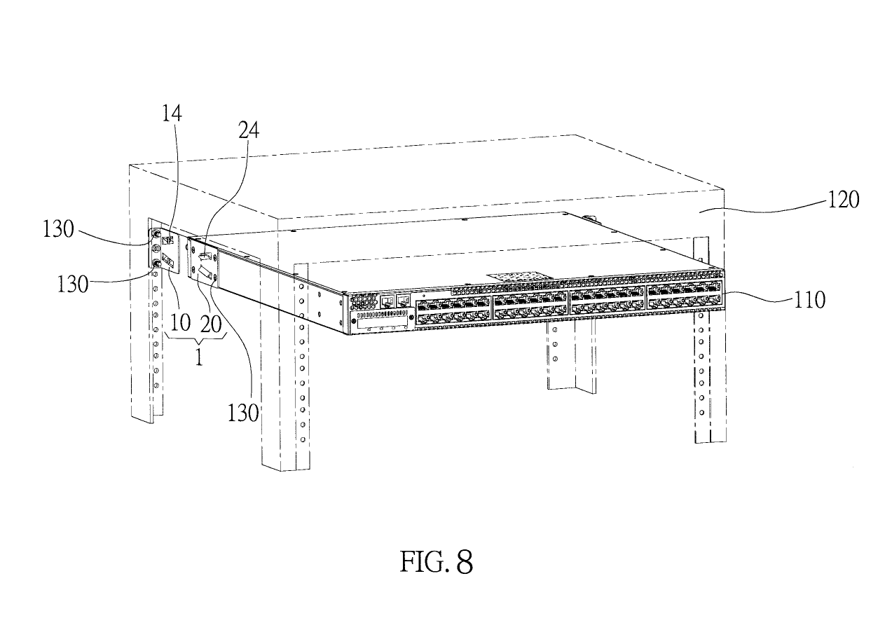

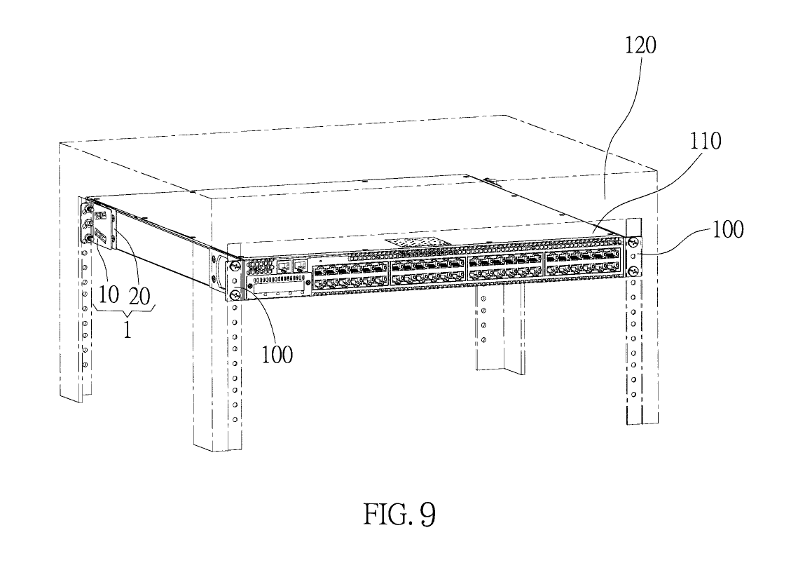

As shown in FIG. 8 and FIG. 9, the coupling device 1 of the present invention could be used to couple and secure two objects, and in this preferred embodiment, one object is a network device 110, and the other object is a rack 120. Before performing the coupling, a user may respectively lock two first members 10 at a predetermined position on the rack 120 by passing a plurality of bolts 130 or other lock members through the through holes 123, and then use the bolts 130 to lock two second members 20 respectively to the both sides at the end of the network device 110. While installing the network device 110, the second members 20 locked on the network device 110 are moved toward the first members 10 locked on the rack 120. Meanwhile, the second conjunction 24 of each second member 20 is located between the first conjunctions 14 of the corresponding first members 10. Since the distance between the first surfaces 14 and the distance between the second surfaces 24 respectively gradually reduce toward the second end 122 and the fourth end 222, the second surfaces 24 are gradually abutted against the first surface 14, which has the effect of quickly guiding, easily aligning, and firmly coupling.

The conventional L-shaped plates 100 could be further used to connect the network device 110 and the rack 120 to better ensure that the network device 110 is secured onto the rack 120 without tilting, deforming, or falling down.

Furthermore, in case the aforementioned coupling device 1 is damaged or consumed, a user could easily separate the second member 20 from the first member 10 by loosening the L-shaped plates 100, and moving the network device 100. In this way, the purpose to maintain and replace parts could be easily achieved.

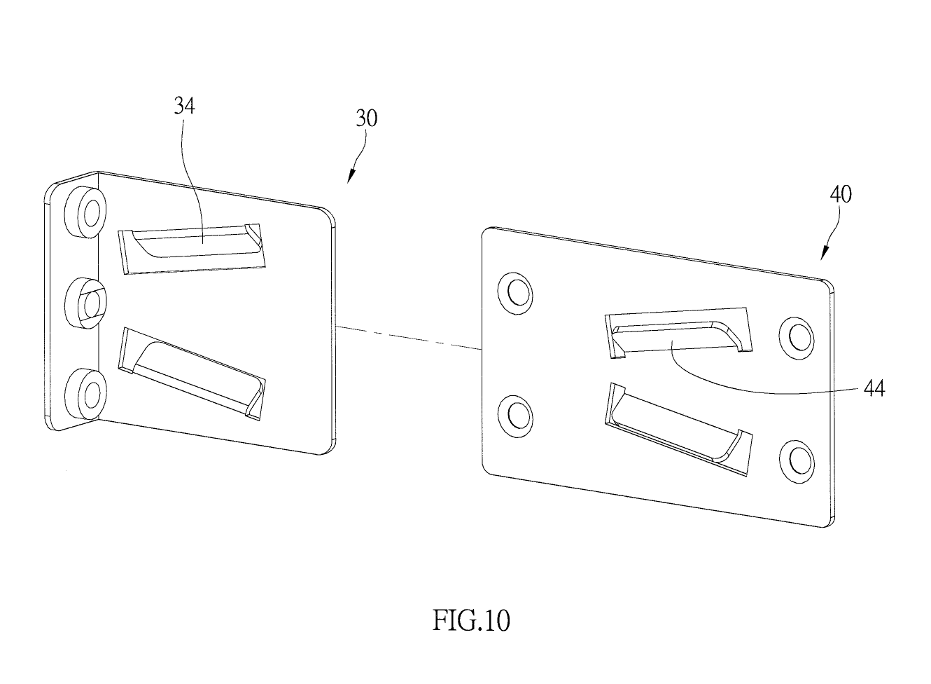

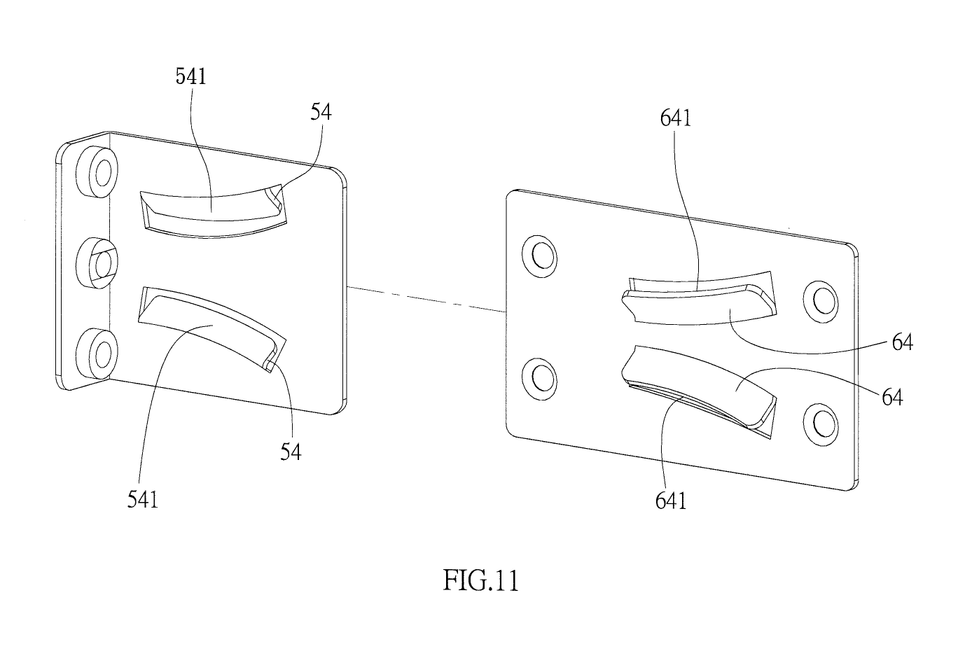

In conclusion, the coupling device 1 of the present invention has simple structure, low manufacturing cost, and can be used to secure a network device quickly and firmly, and therefore the coupling device 1 could lower the cost for human resource and maintenance. In other embodiments, the lengths of the first member and the second member could be extended to perform the same function of the present invention without using the L-shaped plates. As shown in FIG. 10, the first conjunction 34 of the first member 30 and the second conjunction 44 of the second member 40 are both designed as a pair of long plates, and as shown in FIG. 11, the first surfaces 541 of the first conjunction 54 and the second surfaces 641 of the second conjunction 64 are corresponding cambered surfaces. The design shown in FIG. 10 and FIG. 11 could provide the same function of the present invention too. Of course, the coupling device of the present invention not only can be used to secure a network device onto a rack, but also can be used to secure other objects onto other fixtures.

The description above is a few preferred embodiments of the present invention, and the equivalence of the present invention is still in the scope of claim construction of the present invention.

What is claimed is:

1. A coupling device, comprising:
a first member having a first base and a first junction, wherein the first base has a first end and a second end at opposite sides thereof; the first junction has at least two first surfaces which face toward each other; and a distance between the first surfaces near the second end is shorter than a distance between the first surfaces near the first end;
a second member having a second base and a second conjunction, wherein the second base has a third end and a fourth end at opposite sides thereof; the second junction has at least two second surfaces which face away from each other, and a distance between the second surfaces near the fourth end is shorter than a distance between the second surfaces near the third end;
whereby, the first member and the second member can be coupled by abutting the second surfaces against the first surfaces.

2. The coupling device as defined in claim 1, wherein an angle between the first surfaces and the first base is less than 90 degrees.

3. The coupling device as defined in claim 1, wherein an angle between the second surfaces and the second base is less than 90 degrees.

4. The coupling device as defined in claim 1, wherein each second surface is longer than each first surface.

5. The coupling device as defined in claim 1, wherein the distance between the first surfaces gradually reduces from the ends near first end to the ends near the second end.

6. The coupling device as defined in claim 1, wherein the distance between the second surfaces gradually reduces from the end near the third end to the end near the fourth end.

7. The coupling device as defined in claim 1, wherein the first conjunction has a plurality of plates forming two rows, and each two neighboring plates in the same row are separated with a predetermined distance; the first surfaces are on the plates.

8. The coupling device as defined in claim 7, wherein the second conjunction is longer than each plates.

9. The coupling device as defined in claim 1, wherein each first surface and each second surface is flat.

10. The coupling device as defined in claim 1, wherein each first surface and each second surface is cambered.

11. The coupling device as defined in claim 1, wherein the first base has at least one through hole for accepting a lock member.

12. The coupling device as defined in claim 1, wherein the second base has at least one through hole for accepting a lock member.
